(19) United States
(12) Patent Application Publication
(10) Pub. No.: US 2009/0059431 A1
(43) Pub. Date: Mar. 5, 2009

(54) SUSPENSION, HEAD GIMBALS ASSEMBLY, METHOD FOR MANUFACTURING HEAD GIMBALS ASSEMBLY, STORAGE APPARATUS, AND APPARATUS FOR MANUFACTURING HEAD GIMBALS ASSEMBLY

(75) Inventors: Hiroaki Kushima, Kawasaki (JP); Toru Watanabe, Kawasaki (JP); Kenrou Yamamoto, Kawasaki (JP); Tetsuya Takahashi, Kawasaki (JP); Naoki Mukoyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/038,354

(22) Filed: Feb. 27, 2008

(30) Foreign Application Priority Data
Aug. 29, 2007 (JP) 2007-222033

(51) Int. Cl. G11B 5/60; B23P 11/00; B23K 1/00

(52) U.S. Cl. 360/234.6; 29/525.14

(57) ABSTRACT

This head gimbals assembly has a head slider, a flexure, and a load beam. The head slider has a head element and slider-side connection terminals. The flexure has a free end, a fixed end, a slider mounting portion and suspension-side connection terminals connected to the slider-side connection terminals. The load beam fixes a fixed end of the flexure on the side opposite to a flexure surface on which the head slider is mounted a connecting portion for interconnecting the suspension-side connection terminals and the slider mounting portion has higher resiliency than other portion of the connecting portion. According to a suspension in the present embodiment, a head gimbals assembly can be easily manufactured without wastefully discarding the suspension even when the desired evaluation result is not obtained because of problems in the head characteristics and the floating surface of the head slider.

The present invention relates to a suspension, a head gimbals assembly, a method for manufacturing a head gimbals assembly, a storage apparatus, and an apparatus for manufacturing a head gimbals assembly. More particularly, the present invention relates to a suspension, a head gimbals assembly, a method for manufacturing a head gimbals assembly, a storage apparatus, and an apparatus for manufacturing a head gimbals assembly, in each of which a head (head slider) can be removed from the suspension.

### BACKGROUND OF THE INVENTION

In a hard disk drive prevalently used at present, for example, a magnetic recording medium is rotated at a high speed to introduce air into a space between a head slider supported by a suspension and the magnetic recording medium. The head slider is caused to float with pressure generated by the introduced air. The distance between the magnetic recording medium and the head slider in such a state (hereinafter referred to as the “floating amount”) is not constant and differs depending on the shape of a floating surface of the head slider and the elasticity of the suspension. On the other hand, Tens of thousands of heads are manufactured on a wafer of 4 to 5 inches by repeating exposure and development steps. Usually, the individual heads have certain characteristic variations.

Evaluation is performed on the hard disk drive which has been assembled in a head. If the hard disk drive is evaluated to be defective in consideration of variations in the head characteristics and the floating amount, the head gimbals assembly has to be replaced. The replacement of the head gimbals assembly requires the hard disk drive to be disassembled and assembled repeatedly, which is very inefficient.

Therefore, characteristics of a head element have hitherto been evaluated in a state where the head slider including the head element and the suspension for holding the head slider on a magnetic disk are assembled with each other (hereinafter referred to as the “head gimbals assembly”). The head slider is floated on the magnetic recording medium and characteristics of the head element are evaluated by using an evaluation device. If the evaluation result indicates that the characteristics of the head element satisfy the requirements, the head gimbals assembly is assembled into the hard disk drive.

On the other hand, if the characteristics of the head element do not satisfy the requirements and the head element is determined to be defective, the suspension is discarded along with the head slider including the defective head element. Usually, the head slider including the head element and the suspension are fixed to each other by an adhesive, e.g., a thermosetting resin, so that the head slider will not peel off from the suspension. Therefore, once they are fixed to each other, the head slider cannot be removed from the suspension without breaking or deforming the suspension.

In most of the head gimbals assemblies which have been determined to be defective, however, problems reside in the characteristics of the head elements or the shapes of floating surfaces of the head sliders, while the suspensions supporting the head sliders have no problems. Stated another way, discarding the suspensions having no functional problems along with the defective head sliders is a serious issue in consideration of cost efficiency.

As one approach for solving the above-described problem, Japanese Patent Application Laid-Open Publication No. 2004-086976 discloses a test apparatus to which a head slider can be attached in a detachable manner. By employing the test apparatus for testing the head slider alone in a not-yet assembled state, the head slider can be evaluated before it is mounted to the suspension. Accordingly, a loss of the suspension attributable to the defective head element can be prevented.

However, the test apparatus for testing the head slider alone in the not-yet assembled state cannot perform the evaluation taking into account variations in the floating amount described above. In the future, the track pitch and the head slider size will be reduced more and more to be adapted for a further improvement of recording density. From that point of view, a test is required to be performed under conditions that are coincident with those in the state of actual use as close as possible.

Further, Japanese Patent Application Laid-Open Publication No. 2007-012169 discloses a technique of pressing a suspension-side connection terminal having elasticity into pressure contact with a slider-side connection terminal of the head slider including the head element, and receiving the head slider by a stopper disposed on the surface of a suspension onto which surface the head slider is mounted, thereby holding the head slider fixed to the suspension. The proposed technique enables the head slider to be easily attached and detached.

With the technique of fixing the head-slider to the suspension-side connection terminal having elasticity, however, a difficulty arises in managing the elasticity of the suspension-side connection terminal wiring lines on the suspension including the suspension-side connection terminal, which is connected to the head element disposed on the head slider, are usually made of copper as a main component and are very pliable. Further, each wiring line has a very small section of about 20 μm*15 μm. It is therefore difficult to form a supporting portion having large rigidity that is sufficient to fixedly hold the head slider. This results in a difficulty in ensuring stable electrical connection.

Meanwhile, Japanese Patent Application Laid-Open Publication No. 2004-283911 discloses a suspension and a head slider having a dummy pad dedicated for fixation in addition to a pad for both electrical bonding and fixation. More specifically, the head slider is bonded to the suspension by using a solder and is removed from the suspension by remelting the solder. Another head slider including a new head element is bonded to the same suspension by using a solder. The disclosed technique is superior in that stable electrical bonding is obtained and a floating test of the head slider can be performed.

However, the technique of fixing the suspension and the head slider having the dummy pad to each other by the solder bonding causes a shrinkage distortion when the solder hardens. Also, when the ambient temperature is changed, stresses are caused due to heat acting from the slider mounting surface of the suspension through the bonded portion. With the shrinkage distortion and the stresses, the shape of the head slider after the bonding is deformed. Further, the deformation of the head slider affects the floating amount of the head slider which is floated above a magnetic disk, and impedes stable movement of the head element. In addition, when the shrinkage distortion and the deformation are generated to a large extent, rising of the head slider from the suspension (hereinafter referred to as “peeling-off”) is caused.

In view of the state of the art, a first object of the present invention is to provide a suspension, a head gimbals assembly, a method for manufacturing a head gimbals assembly, a storage apparatus, and an apparatus for manufacturing a head gimbals assembly, in each of which a head slider including a head element can be easily attached to and detached from the suspension. A second object of the present invention is to provide a head gimbals assembly, a method for manufacturing a head gimbals assembly, a storage apparatus, and an apparatus for manufacturing a head gimbals assembly, in each of which a head slider will not peel off or deform due to stresses even when the head slider is fixed to a suspension by solder bonding. A third object of the present invention is to provide a head gimbals assembly, a method for manufacturing a head gimbals assembly, a storage apparatus, and an apparatus for manufacturing a head gimbals assembly, in each of which a head slider is firmly fixed to only one end side of a suspension by bonding.

### SUMMARY OF THE INVENTION

In accordance with an aspect of an embodiment, a head gimbals assembly has a head slider, a flexure, and a load beam. The head slider has a head element and slider-side connection terminals. The flexure has a free end, a fixed end, a slider mounting portion and suspension-side connection terminals connected to the slider-side connection terminals. The load beam fixes a fixed end of the flexure on the side opposite to a flexure surface on which the head slider is mounted. A connecting portion for interconnecting the suspension-side connection terminals and the slider mounting portion has higher resiliency than other portions of the connecting portion.

Another aspect of an embodiment is a method for manufacturing a head gimbals assembly having a head slider, a flexure, and a load beam. The method has the steps of arranging the head slider on a slider mounting portion of the flexure, flexing a free end of the flexure toward the side away from a slider mounting surface of the slider mounting portion, electrically connecting slider-side connection terminals of the head slider and suspension-side connection terminals of the flexure to each other while the free end of the flexure is in a flexed state, and releasing the free end of the flexure from the flexed state after the electrical connecting.

### BRIEF DESCRIPTION OF THE DRAWINGS

The present invention will be explained with reference to the accompanying drawings.

FIG. 1 is a plan view of a hard disk drive (storage device) according to the present invention.

FIG. 2A is a plan view showing the structure of a suspension according to a first embodiment of the present invention.

FIG. 2B is an opposite-side plan view showing the structure of a suspension according to a first embodiment of the present invention.

FIG. 2C is a sectional view showing the structure of a suspension according to a first embodiment of the present invention.

FIG. 3 is a plan view showing the structure of a suspension according to a transformation of the present invention corresponding to FIG. 2A.

FIG. 4 is a sectional view showing the structure of a suspension according to a transformation of the present invention corresponding to FIG. 2C.

FIG. 5 is a flowchart of a method for manufacturing a head gimbals assembly according to the first embodiment of the present invention.

FIGS. 6A, 6B and 6C are explanatory views for explaining the method for manufacturing the head gimbals assembly according to the first embodiment of the present invention.

FIG. 7A is a plan view showing the structure of the head gimbals assembly according to the first embodiment of the present invention.

FIG. 7B is a sectional view showing the structure of the head gimbals assembly according to the first embodiment of the present invention.

FIGS. 8A and 8B are sectional views showing the structure of a suspension according to a second embodiment of the present invention.

FIG. 9 is a schematic view of an apparatus for manufacturing the head gimbals assembly according to the embodiment of the present invention.

### DETAILED DESCRIPTION

Embodiments of the present invention will be described in detail below with reference to the accompanying drawings.

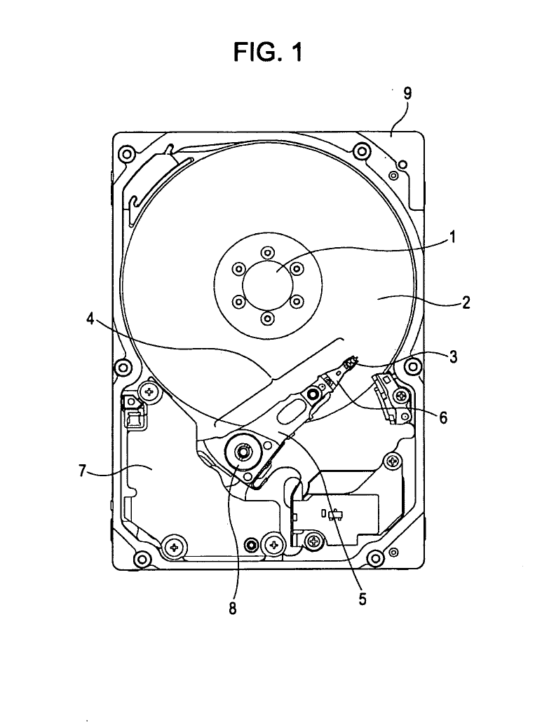

FIG. 1 is a plan view of a hard disk drive (storage apparatus) according to the present invention. A magnetic recording medium 2 fixed to a spindle motor 1 is rotated at a high speed to introduce air into a space between a head slider 3 and the magnetic recording medium 2. The head slider 3 is caused to float with pressure generated by the introduced air. An actuator 4 includes a head gimbals assembly 6 disposed at one end of a carriage 5 and a voice coil motor 7 disposed at the other end of the carriage 5. The actuator 4 is rotatably fixed to a housing 9 with a shaft supported through a bearing 8 such that the actuator 4 is movable substantially in the radial direction of the magnetic recording medium 2. Therefore, the head slider 3 attached to one end of the head gimbals assembly 6 is also movable over the magnetic recording medium 2 substantially in the radial direction. A head mounted to the head slider 3 is positioned on a predetermined track to perform recording or reading of information.

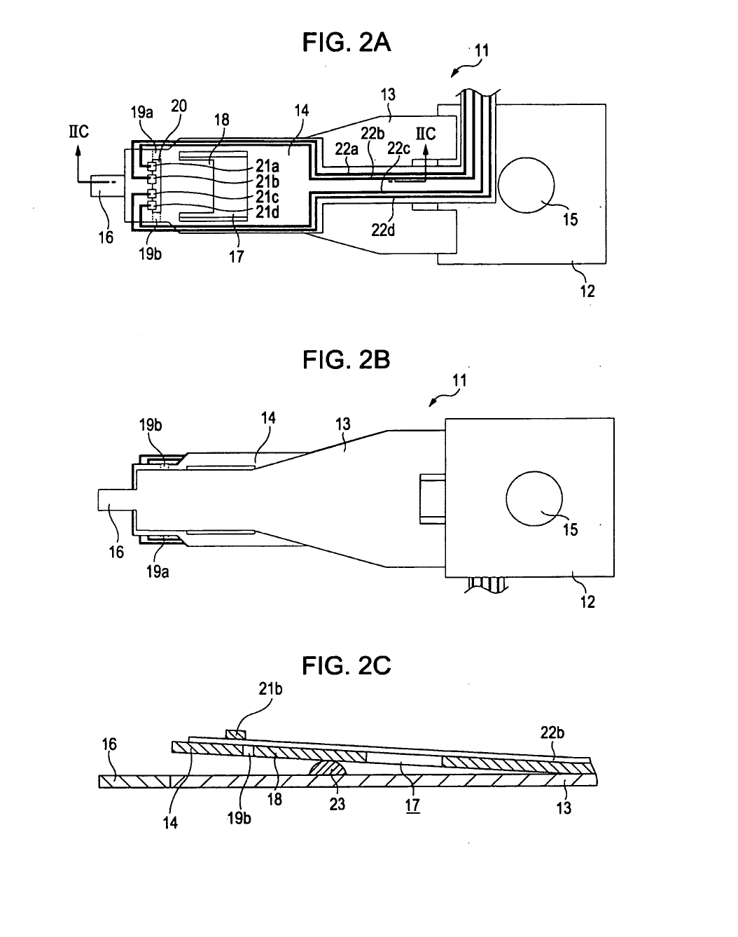

FIG. 2A is a plan view of a suspension 11 according to the first embodiment of the present invention, the view showing the structure of the suspension on the side to which the head slider is mounted. FIG. 2B is an opposite-side plan view of the suspension, looking from the opposite side to FIG. 2A. FIG. 2C is a sectional view taken along a line IIC-IIC in FIG. 2A. The suspension 11 according to the first embodiment of the present invention mainly comprises a load beam 13 having relatively high rigidity, a flexure 14 having relatively high elasticity, and a base plate 12.

The base plate 12 has a through hole 15 used for fixedly mounting the suspension to an actuator arm (not shown). The load beam 13 has a dimple 23 which is formed at a position under a slider mounting portion 18 of the flexure 14 and serves as a load acting point. Also, in this embodiment, the load beam 13 has a load bar 16 which is formed at its free end in the longitudinal direction for loading and unloading. However, the load beam 13 can be dispensed with when the so-called contact start/stop method is employed. In addition, the load beam 13 has bent portions (not shown) at both the sides in the widthwise direction for the purpose of increasing rigidity.

The flexure 14 is formed of a thin spring sheet. The flexure 14 is held by the dimple 23 of the load beam 13 to be displaceable in the roll and pitch directions. Even with a magnetic recording medium having small undulations, therefore, the head slider can exactly follow the magnetic recording medium without being constrained to the suspension surface. Thus, the flexure 14 stabilizes the floating of the head slider. Further, the flexure 14 has the slider mounting portion 18 surrounded by a flexure opening 17. In addition, the flexure 14 has suspension-side connection terminals 21a-21d which are arranged at positions on the side opposed to slider-side connection terminals with a terminal opening 20 interposed there between when the head slider is disposed in place. The suspension-side connection terminals 21a-21d are connected to an external detection circuit (not shown) through conductive wires 22a-22d, respectively.

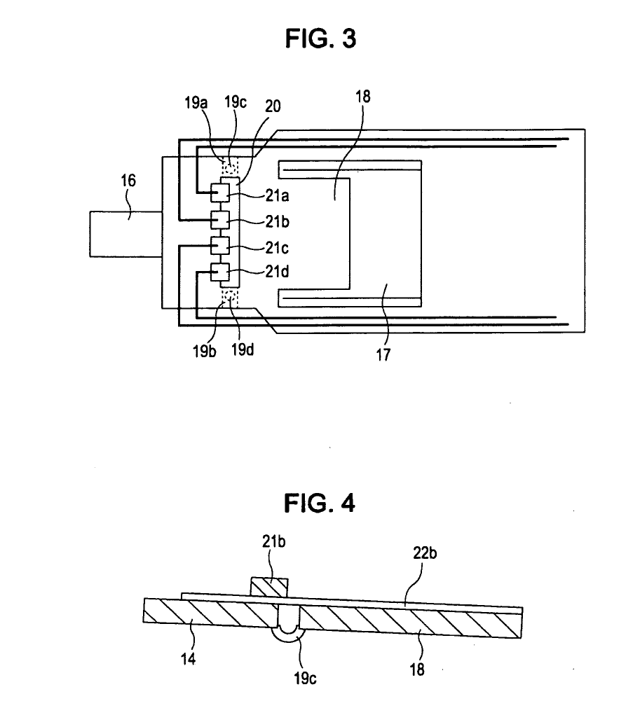

Moreover, the flexure 14 has connecting portions 19a and 19b on both the sides of the terminal opening 20. The terminal opening 20 serves to prevent direct conduction of heat toward the head slider side, the heat being generated during bonding of the terminals. By increasing elasticity of the connecting portions 19a and 19b which interconnect the suspension-side connection terminals 21a-21d and the slider mounting portion 18, the head gimbals assembly according to the present invention can be more stably manufactured when the suspension is used in a later-described method for manufacturing the head gimbals assembly according to the present invention. It is to be noted that while the elasticity of the connecting portions is increased by reducing a thickness in the illustrated embodiment, higher elasticity can also be realized by forming one or more openings 19c and 19d or bending portion 19e as FIGS. 3 and 4.

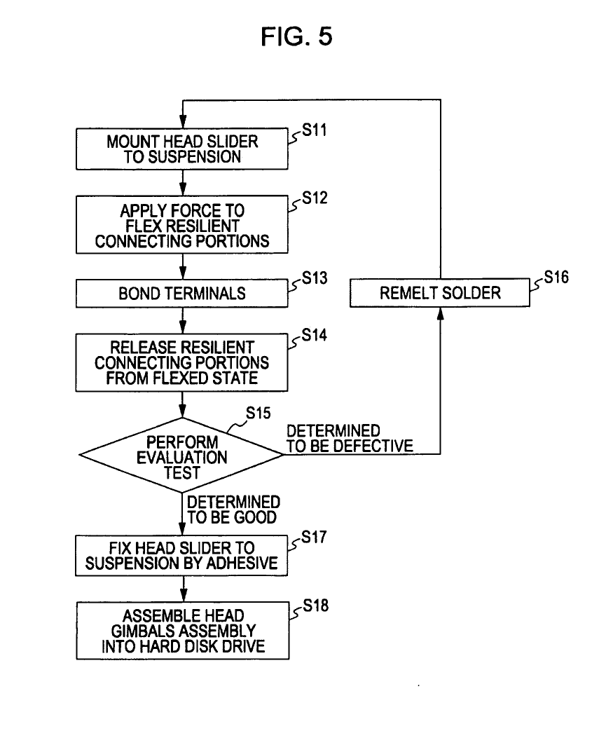

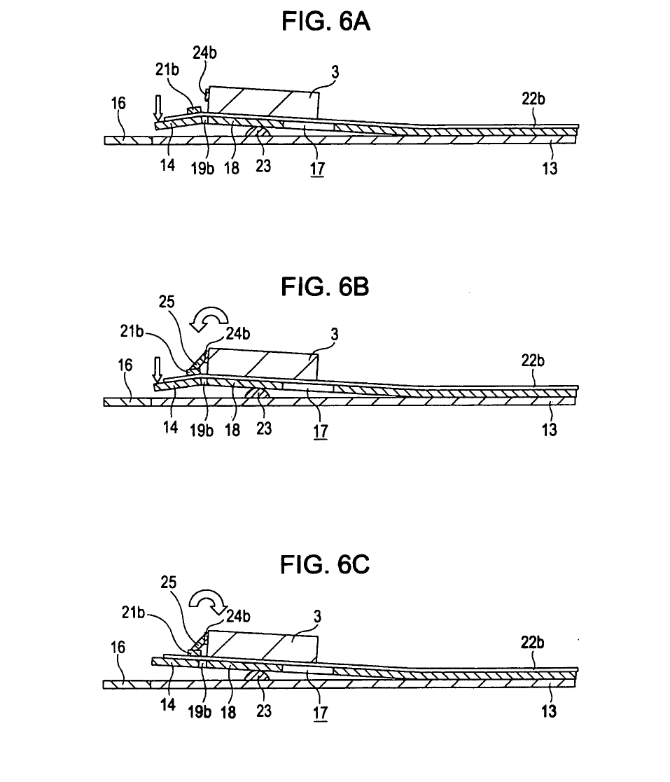

The method for manufacturing the head gimbals assembly according to the present invention will be described below. FIG. 5 is a flowchart of the method for manufacturing the head gimbals assembly according to the first embodiment of the present invention. FIGS. 6A, 6B and 6C are explanatory views for explaining the method for manufacturing the head gimbals assembly according to the first embodiment of the present invention, each of FIGS. 6A, 6B and 6C corresponding to the sectional view of FIG. 2C. First, as shown in FIG. 6A, the head slider 3 is disposed on the slider mounting portion 18 of the suspension (S11 in FIG. 5). Then, a force is applied to a free end of the flexure 14 to flex the connecting portions 19a and 19b toward the side away from a slider mounting surface of the slider mounting portion 18 (S12). Then, as shown in FIG. 6B, slider-side connection terminals 24a-24d (24b is shown) are bonded respectively to the suspension-side connection terminals 21a-21d by using a solder 25 while maintaining the connecting portions 19a and 19b (19b is shown) in the flexed state (S13). Further, as shown in FIG. 6C, the connecting portions 19a and 19b are released from the flexed state after the solder 25 has hardened (S14).

When the solder 25 hardens with dissipation of heat, a moment is generated in the head slider 3 due to shrinkage of the solder as indicated by an arc-shaped arrow in FIG. 6B. The moment causes a stress acting on the head slider 3 to peel off it from the slider mounting portion 18. However, since the connecting portions 19a and 19b are released from the flexed state after the solder bonding, the moment acting on the head slider 3 can be reduced by elasticity energy of the connecting portions 19a and 19b, or a moment can be generated, as indicated by an arc-shaped arrow in FIG. 6C, to press the head slider 3 against the slider mounting portion 18. Accordingly, the head slider 3 can be prevented from peeling off or deforming. In this embodiment, the slider-side connection terminals 24a-24d and the suspension-side connection terminals 21a-21d are joined to each other by the solder bonding. However, the advantages of the present invention can also be obtained by using any suitable other method, e.g., thermal compression bonding or ultrasonic bonding, so long as the method generates a stress causing shrinkage or expansion.

Further, characteristic evaluation is performed on the thus-assembled head gimbals assembly by, e.g., a floating evaluation test (S15). In this state, the stress caused by the shrinkage of the solder is already removed otherwise, the connecting portions 19a and 19b of the flexure 14 generate the moment acting on the head slider 3 through the solder 25 to press the head slider 3 against the slider mounting portion 18. It is hence ensured that the head slider 3 is held fixed to the suspension. Therefore, the head slider 3 is reliably prevented from peeling off during the evaluation test and the evaluation can be stably performed.

If the head gimbals assembly is determined to be defective as a result of the evaluation, the solder 25 is remelted (S16). After such a step, the head slider 3 can be easily replaced with another new one without discarding the suspension. A bonding material used to bond the suspension-side connection terminals 21a-21d and the slider-side connection terminals 24a-24d respectively is not limited to the solder 25 and it may be, for example, a metal such as gold or copper, or a conductive adhesive. Note that the bonding material is preferably easily removable from the viewpoint of enabling the head slider 3 to be attached and detached with ease. In addition, if necessary, cleaning may be performed to make the suspension-side connection terminals 21a-21d clean.

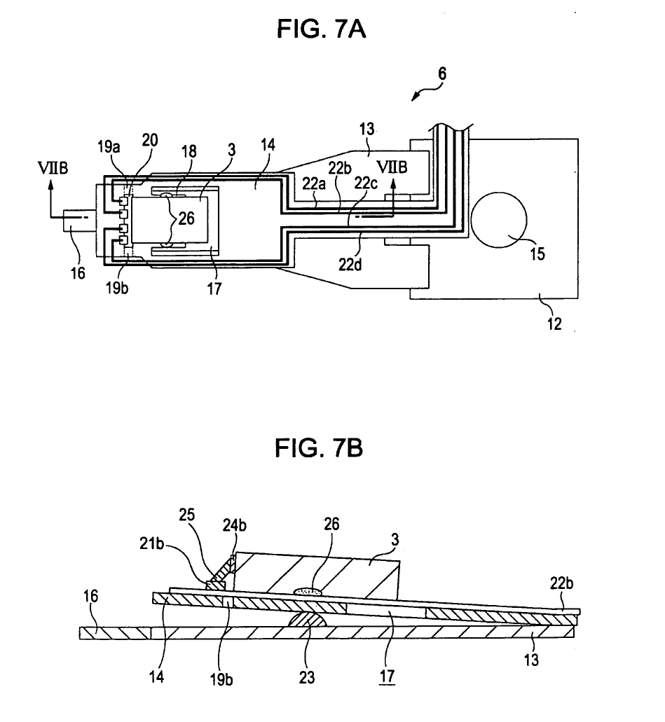

A process executed in the case where the head gimbals assembly is determined to be good will now be described with reference to FIGS. 7A and 7B. FIG. 7A is a plan view showing the structure of the head gimbals assembly according to the first embodiment of the present invention, looking from the same side as the slider mounting surface. FIG. 7B is a sectional view taken along a line VIIB-VIIB in FIG. 7A. As shown in FIGS. 7A and 7B, if the head gimbals assembly is determined to be good, an adhesive 26 is applied so as to permeate between the head slider 3 and the slider mounting portion 18, thereby firmly fixing the head slider 3 to the suspension (S17). The completed head gimbals assembly is then assembled into a hard disk drive (S18). At that time, the adhesive and the adhesive-applied positions are preferably selected so that a thermal stress acting on the head slider from the slider mounting surface is minimized. Alternatively, in the case of the determination result being good, the completed head gimbals assembly may be assembled into a hard disk drive; as it is, without applying an adhesive.

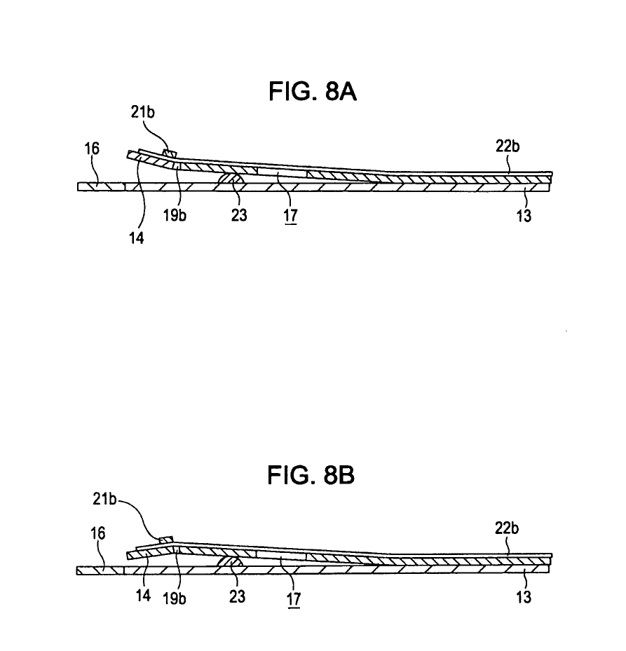

The head gimbals assembly can also be manufactured by using a suspension in which a portion of the flexure 14 near the suspension-side connection terminals 21a-21d is bent in advance toward the same side as the slider mounting surface or the opposite side. Such pre-bending is effective in giving a sufficient pressing force to the head slider 3, or suppressing the flexion amount of the portion of the flexure 14 near the suspension-side connection terminals 21a-21d (21b is shown) after the assembly within a desired range. FIGS. 8A and 8B show a second embodiment of a suspension according to the present invention. FIGS. 8A and 8B are each a sectional view of the suspension corresponding to FIG. 2C. As shown in FIGS. 8A and 8B, preferably, the connecting portions 19a and 19b (19b is shown) of the flexure 14 are subjected to the pre-bending in one direction toward the same side as the slider mounting surface or the opposite side.

The method for manufacturing the head gimbals assembly has been described above, by way of example, in connection with the case of using the suspension according to the embodiment of the present invention. Even in the case of using a conventional suspension, however, because the conventional suspension has resiliency in itself, the method for manufacturing the head gimbals assembly according to the present invention can also be applied by flexing a part of the conventional suspension, which corresponds to the connecting portions 19a and 19b.

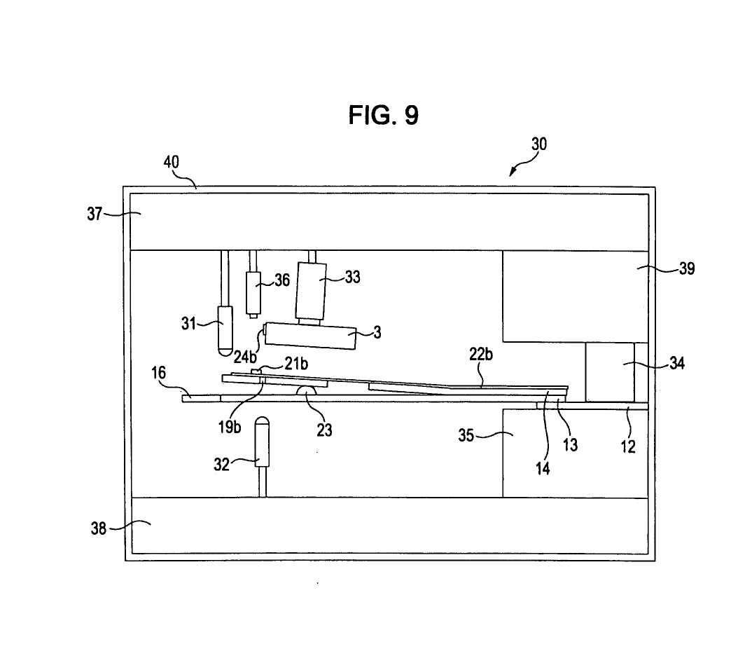

An apparatus for manufacturing the head gimbals assembly according to the embodiment of the present invention will be described below. FIG. 9 is a schematic view of an apparatus 30 for manufacturing the head gimbals assembly according to the embodiment of the present invention. The apparatus 30 for manufacturing the head gimbals assembly according to the embodiment of the present invention mainly comprises a first support unit 31, a first jig 33, a second support unit 32, a second jig 34, and a solder bonding unit 36, which are all installed within an apparatus housing 40. The first support unit 31 is connected to an upper-side first driving unit 37. The second support unit 32 is connected to a lower-side second driving unit 38.

The base plate 12 of the suspension is placed on a stationary base 35 and the second jig 34 is movable downward toward the base plate 12 to hold the suspension fixed. For that purpose, the stationary base 35 or the second jig 34 is provided with a projection engaging in the mounting through hole 15 of the base plate 12. Further, the first support unit 31, the first jig 33, and the solder bonding unit 36 are also connected to the upper-side first driving unit 37 and have such a structure that each component is movable in a direction substantially perpendicular to the slider mounting surface of the suspension. Similarly, the second support unit 32 is connected to the lower-side second driving unit 37 and has such a structure that it is movable in the direction substantially perpendicular to the slider mounting surface of the suspension.

The first support unit 31 is moved downward in accordance with an instruction from a control unit 39 to apply a force to the free end of the flexure 14. The second support unit 32 is moved upward in accordance with an instruction from the control unit 39 to support the connecting portions 19a and 19b of the flexure 14. The first jig 33 can be moved downward with holding the head slider 3 by, e.g., suction in accordance with an instruction from the control unit 39. The solder bonding unit 36 is moved downward in accordance with an instruction from the control unit 39 and performs solder bonding between the slider-side connection terminals 24a-24d and the suspension-side connection terminals 21a-21d. The solder bonding unit 36 can be constituted to have solder bonding units in the same number as the terminal number for each group of the slider-side connection terminals and the suspension-side connection terminals so that all the terminals may be bonded at the same time. Alternatively, the solder bonding unit 36 can be constituted to have a single solder bonding unit such that the paired terminals are successively bonded one by one.

With the suspension, the head gimbals assembly, the method for manufacturing the head gimbals assembly, and the apparatus for manufacturing the head gimbals assembly according to the present invention, the head gimbals assembly can be easily manufactured without wastefully discarding the suspension even when the desired evaluation result is not obtained because of problems in the head characteristics and the floating surface of the head slider. Therefore, the suspension can be reused and the loss cost in the manufacturing of the hard disk drive can be reduced. Further, the characteristic evaluation of a head element in the head gimbals assembly can be stably performed in spite of enabling the head slider to be easily attached and detached. In addition, since the head slider is fixed only at one end side, a thermal stress receiving from the slider mounting surface can be greatly reduced and the head slider can be prevented from deforming due to changes of the ambient temperature.

What is claimed is:

1. A suspension for supporting a head slider on a medium comprising:
a flexure having a free end, a fixed end, a slider mounting portion and suspension-side connection terminals connected to slider-side connection terminals; and
a load beam fixing a fixed end of the flexure on the side opposite to a flexure surface on which the head slider is mounted,
wherein a connecting portion for interconnecting the suspension-side connection terminals and the slider mounting portion has higher resiliency than other portion of the connecting portion.

2. The suspension according to claim 1, wherein the connecting portion has a smaller thickness than the other portion of the connecting portion.

3. The suspension according to claim 1, wherein the connecting portion has two or more holes.

4. The suspension according to claim 1, wherein the connecting portion is bent.

5. A head gimbals assembly comprising:
a head slider having a head element and slider-side connection terminals;
a flexure having a free end, a fixed end, a slider mounting portion and suspension-side connection terminals connected to the slider-side connection terminals; and
a load beam fixing a fixed end of the flexure on the side opposite to a flexure surface on which the head slider is mounted,
wherein a connecting portion for interconnecting the suspension-side connection terminals and the slider mounting portion has higher resiliency than other portion of the connecting portion.

6. The head gimbals assembly according to claim 5, wherein the connecting portion has a smaller thickness than the other portion of the connecting portion.

7. The suspension according to claim 5, wherein the connecting portion has two or more holes.

8. The suspension according to claim 5, wherein the connecting portion is bent.

9. A storage apparatus including the head gimbals assembly according to claim 5.

10. A storage apparatus including the head gimbals assembly according to claim 6.

11. A storage apparatus including the head gimbals assembly according to claim 7.

12. A storage apparatus including the head gimbals assembly according to claim 8.

13. A method for manufacturing a head gimbals assembly having a head slider, a flexure, and a load beam, comprising the steps of:
arranging the head slider on a slider mounting portion of the flexure;
flexing a free end of the flexure toward the side away from a slider mounting surface of the slider mounting portion;
electrically connecting slider-side connection terminals of the head slider and suspension-side connection terminals of the flexure to each other while the free end of the flexure is in a flexed state; and
releasing the free end of the flexure from the flexed state after the electrical connecting.

14. The method for manufacturing the head gimbals assembly according to claim 13, wherein the electrical connecting is performed by soldering.

15. The method for manufacturing the head gimbals assembly according to claim 13, further comprising the steps of:
evaluating the head gimbals assembly after releasing the free end of the flexure from the flexed state; and
fixing the head slider to the slider mounting portion by an adhesive.

16. The method for manufacturing the head gimbals assembly according to claim 14, further comprising the steps of:
evaluating the head gimbals assembly after releasing the free end of the flexure from the flexed state; and
fixing the head slider to the slider mounting portion by an adhesive.

17. The method for manufacturing the head gimbals assembly according to claim 15, wherein the step of evaluating the head gimbals assembly is performed in a state that the head slider is floated on a medium.

18. The method for manufacturing the head gimbals assembly according to claim 16, wherein the step of evaluating the head gimbals assembly is performed in a state that the head slider is floated on a medium.
